(19) United States
(12) Patent Application Publication
(10) Pub. No.: US 2015/0373436 A1
(43) Pub. Date: Dec. 24, 2015

(54) MULTIPLE-VOCAL COIL COAXIAL AUDIO SPEAKER USING SINGLE AUDIO SOURCE

(71) Applicant: Huiyang Dongmei Audio Products Co., Ltd., Guang Dong (CN)

(72) Inventors: Ming-Chung CHU, New Taipei City (TW); Pin-Tang LEE, New Taipei City (TW); Taniguchi SHOICHI, Nara (JP)

(21) Appl. No.: 14/309,406

(22) Filed: Jun. 19, 2014

(51) Int. Cl. H04R 1/02; H04R 3/00

(52) U.S. Cl. CPC H04R 1/02; H04R 3/00

(57) ABSTRACT

A disclosed coaxial audio speaker may include a treble sound unit and a bass sound unit co-axially surrounding the treble sound unit. The bass sound unit may be in form of a dual magnetic gap mechanism and have a vibrating vocal tone diaphragm along with a wiring board. The bass sound unit may further include a magnetic resistant ring selectively disposed therein. Within the magnetic resistant ring lies the treble sound unit. Therefore, the size of the audio speaker may be reduced because of the co-axially disposed bass sound unit and the treble sound unit. And the broader electricity adjustability may be achieved as vibration audio source points of the bass sound unit and the treble sound unit may be horizontally aligned.

### BACKGROUND

1. Technical Field

The present disclosure relates to an audio speaker, in particular, to a multiple-vocal coil coaxial audio speaker using a single audio source. Specially, the audio speaker employs a bass sound unit and a treble sound unit surrounded by the bass sound unit. Further, a vibration audio source point of the bass sound unit and a vibration audio source point of the treble sound unit may be aligned at the same horizontal level.

2. Description of Related Art

Traditional earphones or audio speakers are equipped with one single amplifier (sound unit) and that renders difficult the realization of a broad range of listening experience. And certain tradeoff becomes necessary if the bass performance needs to be enhanced (at the expense of the treble performance). Even for achieving the goal of the above mentioned broad listening experience, multiple separate sound units (for example, distinct treble sound unit and bass sound unit) need to be placed within the earphones or the audio speakers, occupying additional space inside the earphones or the audio speakers and inevitably increasing the size of the same.

### SUMMARY OF THE DISCLOSURE

In order to overcome the aforementioned deficiency, the present disclosure provides a multi-vocal coil coaxial audio speaker using a single audio source. Specifically, the present disclosure audio speaker may have the bass sound unit coaxially surrounding the treble sound unit, effectively reducing the size of the audio speaker. Meanwhile, the present disclosure audio speaker may be adapted to have vibration audio source points at the same horizontal level, enabling a broader range of electricity adjustability for the sound units.

The multi-vocal coil coaxial audio speaker according to the present disclosure may include a treble sound unit with a vibration audio source point and a wiring board, and a bass sound unit in form of a dual magnetic gap mechanism with a vibrating vocal tone diaphragm having multiple vocal coils, and a wiring board. The bass sound unit may be associated with first and second vibration audio source points. The bass sound unit and the treble sound unit may be coaxially disposed and the treble sound unit may be adapted to be surrounded by the bass sound unit. The vibration audio source point of the treble sound unit may horizontally align with the vibration audio source point of the bass sound unit.

Specifically, the treble sound unit may be an electromagnetic moving iron sound unit, a circular electromagnetic sound unit, a rectangular electromagnetic sound unit, a moving-coil sound unit, piezo-ceramic sound piece components, a piezo-ceramic sound piece adjoining another vibrating vocal tone diaphragm or a semiconductor chip sound unit.

Specifically, a magnetic resistant ring may be disposed at the position where the co-axially disposed bass sound unit and treble sound unit adjoin, for separating a magnetic field of the bass sound unit and a magnetic field of the treble sound unit.

Specifically, the magnetic resistant ring may be a column structure allowing for the treble sound unit to punch through and position therein with a magnetic-conductive base of the bass sound unit surrounding the magnetic resistant ring.

Specifically, the bass sound unit may further include a ring-shaped magnetic-conductive base, which defines a hollow positioning space at its center within which the treble sound unit is positioned, and a main body of the ring-shaped magnetic-conductive base has a ring-shaped accommodating space having a top opening. The main body of the ring-shaped magnetic-conductive base forms an inner wall and an outer wall of the top opening. The bass sound unit may also include a ring-shaped magnet disposed at the center of the ring-shaped accommodating space. The ring-shaped magnet and the inner wall and the outer wall could define a first magnetic gap and a second magnetic gap, respectively. Plus, the bass sound unit may also include a magnetic-conductive ring stationed on a top surface of the ring-shaped magnet. The vibrating vocal tone diaphragm may include a ring-shaped diaphragm membrane stationed on ends of the inner wall and the outer wall of the main body of the ring-shaped magnetic-conductive base. And a first vocal coil may be disposed in an inner ring edge of the ring-shaped diaphragm membrane and the first vibration audio source point may be formed at the position where the first vocal coil connects to the ring-shaped diaphragm membrane. And a second vocal coil may be disposed in an outer ring edge of the ring-shaped diaphragm membrane and the second vibration audio source point may be formed at the position where the second vocal coil connects to the ring-shaped diaphragm membrane. The first vocal coil may extend into the first magnetic gap while the second vocal coil may extend into the second magnetic gap. The ring-shaped magnet may be disposed between the first vocal coil and the second vocal coil. The bass sound unit may further include the wiring board disposed on an external bottom surface of the ring-shaped magnetic-conductive base providing connection wires for positioning the first and the second vocal coils.

The accommodating space may be U-shaped having the inner ring edge and the outer ring edge. The vibrating vocal tone diaphragm may further include an external pressurized frame positioned at the outer ring edge of the ring-shaped diaphragm membrane and an inner pressurized frame positioned at the inner ring edge of the ring-shaped diaphragm membrane. The inner pressurized frame connects to the end of the inner wall of the ring-shaped magnetic-conductive base, and the outer pressurized frame connects to the end of the outer wall and encloses the top opening of the ring-shaped magnetic-conductive base.

A vent hole is disposed on the external bottom surface of the ring-shaped magnetic-conductive base allowing for an air associated with the vibration of the vibrating vocal tone diaphragm to be channeled out of the ring-shaped accommodating space.

A flow damping gauze may be adhesively attached on the external bottom surface of the ring-shaped magnetic-conductive base for adjusting an air flow within the accommodating space.

The ring-shaped diaphragm membrane is in form of composite diaphragm material made of an upper layer composite thin-film membrane and a lower layer composite thin-film membrane.

Dust covers may be disposed over the bass sound unit and the treble sound unit, respectively. For example, a first dust cover having a first sound hole allowing for the sound from the bass sound unit to be transmitted out of the first dust cover may lay over the bass sound unit, and a second dust cover having a second sound hole allowing for the sound from the treble sound unit to be transmitted out of the second dust cover may lay over the treble sound unit.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows an exploded view of a multi-vocal coil coaxial audio speaker according to one embodiment of the present disclosure;

FIG. 2 shows a cross-sectional view of the audio speaker in FIG. 1 according to one embodiment of the present disclosure;

FIG. 3 shows a front view of the audio speaker in FIG. 1 according to one embodiment of the present disclosure;

FIG. 4 shows a back view of the audio speaker in FIG. 1 according to one embodiment of the present disclosure;

FIG. 5 is another multi-vocal coil coaxial audio speaker according to one embodiment of the present disclosure;

FIG. 6 is an exploded view of the audio speaker in FIG. 5 according to one embodiment of the present disclosure;

FIGS. 7A-7F show the embodiments of the treble sound unit of the audio speaker according to one embodiment of the present disclosure; and

FIG. 8 is a schematic diagram of a vibrating vocal tone diaphragm of the audio speaker according to one embodiment of the present disclosure.

### DESCRIPTION OF THE EXEMPLARY EMBODIMENTS

The aforementioned and other technical contents, features, and efficacies will be shown in the following detail descriptions of a preferred embodiment corresponding with the reference Figures.

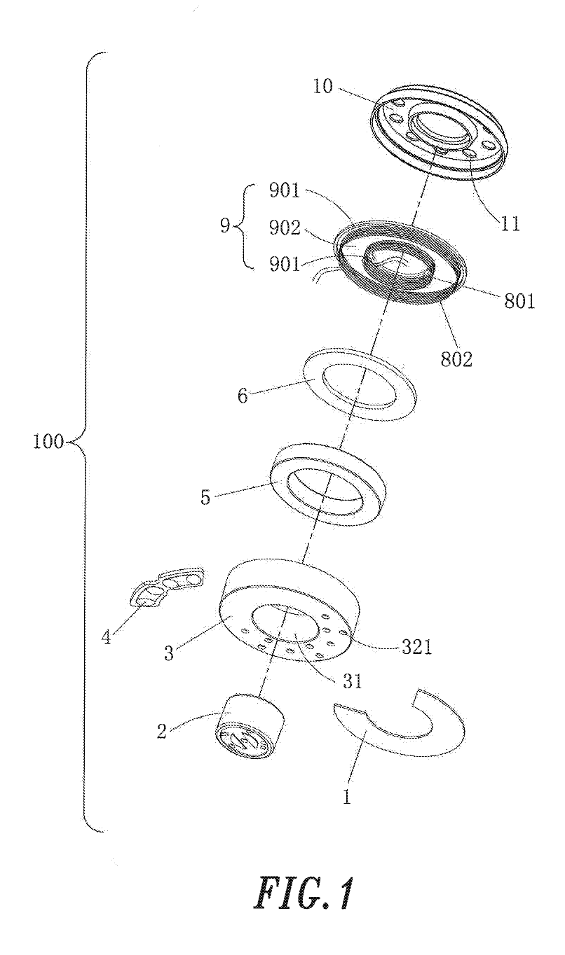

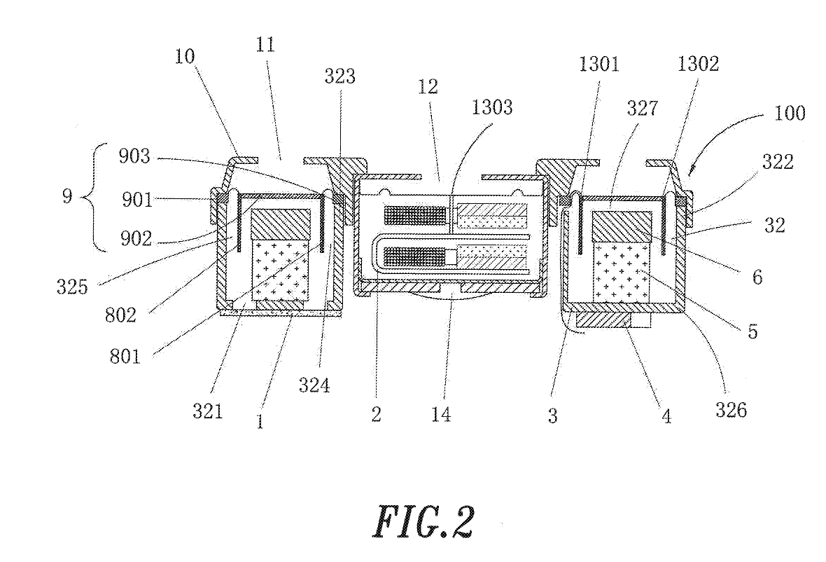

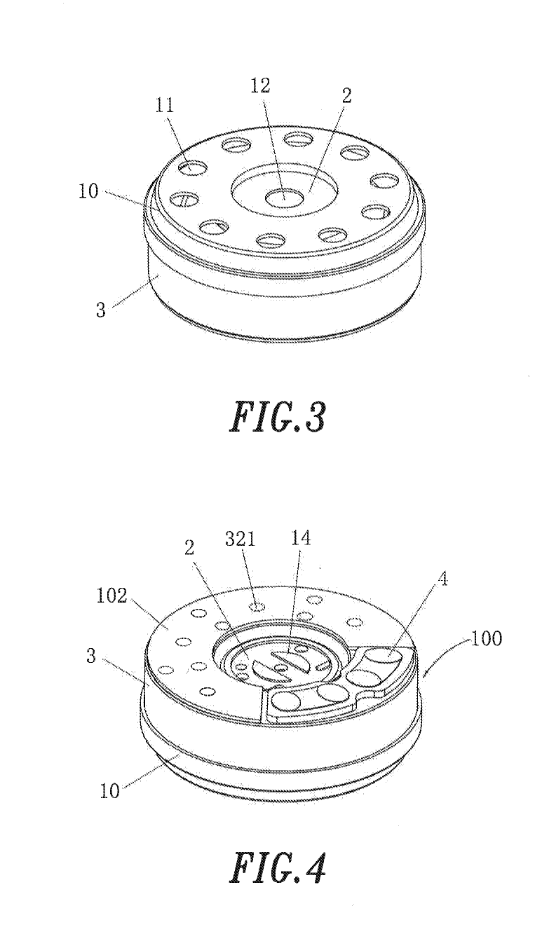

Please refer to FIGS. 1-4 illustrating a multi-vocal coil coaxial audio speaker using a single audio source according to one embodiment of the present disclosure. The audio speaker may include a combination of a bass sound unit 100 and a treble sound unit 2, with the bass sound unit 100 and the treble sound unit 2 coaxially disposed. And the bass sound unit 100 may coaxially surround the treble sound unit 2. The treble sound unit 2 may include a vibration audio source point 1303 and a wiring board 14 for the treble sound unit 2. In one implementation, the treble sound unit 2 may be a moving iron treble sound unit.

The bass sound unit 100 may be implemented in terms of a dual magnetic gap mechanism. The bass sound unit 100 may include a ring-shaped magnetic-conductive base 3. A positioning space 31 may be formed at a hollow center of the ring-shaped magnetic-conductive base 3. A main body of the ring-shaped magnetic-conductive base 3 may include an accommodating space 32 with a top opening 327 and the main body may be formed by an inner wall 323 and an outer wall 322 so that the main body may be U-shaped. Away from the top opening 327 defines an enclosed bottom surface 326 where a vent hole 321 is placed.

A ring-shaped magnet 5 may be positioned within the accommodating space 32 of the ring-shaped magnetic-conductive base 3. The magnet 5 may be disposed at the center of the accommodating space 32 and the bottom surface of the magnet 5 may be fixed upon the enclosed bottom surface 326 of the accommodating space 32. The top surface of the magnet 5 may be adhesively attached to a magnetic-conductive ring 6, which may not protrude from the top opening 327. In one implementation, the size of the magnet 5 is smaller than the cross section and the height of the accommodating space 32. The inner wall 323 and the outer wall 322 and the magnet 5 may form a first magnetic gap 324 and a second magnetic gap 325, respectively. In other words, the magnet 5 may define the accommodating space 32 into the first magnetic gap 324 and the second magnetic gap 325.

A vibrating vocal tone diaphragm 9 may be integrated with the top opening 327. The vibrating vocal tone diaphragm 9 may be composed by a ring-shaped external pressurized frame 901, a diaphragm membrane 902, and a ring-shaped internal pressurized frame 903. The ring-shaped diaphragm membrane 902 may be with an outer ring edge and an inner ring edge. The inner ring edge may be where the ring-shaped inner pressurized frame 903 is positioned while the outer ring edge may be where the ring-shaped external pressurized frame 901 is positioned. The external pressurized frame 901 may be connected to the end of the outer wall and the internal pressurized frame 903 may be connected to the end of the inner wall, so as to enclose the ring-shaped magnetic-conductive base 3. A first vocal coil 801 may be disposed in the proximity of the inner ring edge and a second vocal coil 802 may be disposed in the proximity of the outer ring edge. As such, the diaphragm membrane 902 may be formed with one inner ring (the first vocal coil 801) and one outer ring (the second vocal coil 802). The location where the first vocal coil 801 and the diaphragm membrane 902 are adjoined may form a first vibration audio source point 1301. The location where the second vocal coil 802 and the diaphragm membrane 902 are adjoined may form a second vibration audio source point 1302. The first vocal coil 801 may extend into the first magnetic gap 324 and the second vocal coil 802 may extend into the second magnetic gap 325. The magnet 5 may be positioned between the first vocal coil 801 and the second vocal coil 802.

Magnetic fields provided by the magnet 5 may be conductive present the magnetic-conductive ring 6 along with the first vocal coil 801 and the second vocal coil 802 providing the magnetic gap and the magnetic-conductive base 3 further serving to render conductive the magnetic fields. The vent hole 321 may allow for the air associated with the vibration of the vibrating vocal tone diaphragm 9 to be channeled out.

As shown in FIG. 8, the diaphragm membrane 902 may be a composite diaphragm material composed of an upper layer composite thin-film membrane 9021 and a lower layer composite thin-film membrane 9022. And the diaphragm membrane 902 may be polymer plastic, plastic polymer fibers, organic fibers, mineral matters or the like and in the form of a thin film. In another implementation, the diaphragm membrane 902 may be formed by braided-type punching and forming. The mineral matters may include metals, rocks, minerals, glasses, or combinations of the above. The outer pressurized frame 901 or the inner pressurized frame 903 may not be ring-shaped. In other words, the outer pressurized frame 901 or the inner pressurized frame 903 may be oval, triangular, rectangular, polygonal, or in other shape.

A wiring board 4 may be adhesively attached to an external bottom wall of the magnetic-conductive base 3. The wiring board 4 may allow for the first vocal coil 801 and the second vocal coil 802 to be positioned by welding.

That the treble sound unit 2 is positioned within the positioning space 31 by connecting means, such as adhesion, engaging, or other commercially available connecting approaches. The bass sound unit 100 may be disposed around the treble sound unit 2, so the bass sound unit 100 may co-axially surround the treble sound unit 2. The first vibration audio source point 1301 and the second vibration audio source point 1302 of the bass sound unit 100 may be at the same horizontal level with the vibration audio source point 1303 of the treble sound unit 2. Thus, the audio speaker according to the present disclosure may be with a broader range of electricity adjustability, and the audio speaker having multi-coil, coaxial one single audio source can make both bass and treble sounds.

The wiring board 14 of the magnetized treble sound unit and the wiring board 4 of the magnetized bass sound unit may be connected to electrical signal wires.

The magnetic-conductive base 3 may be having flow damping gauze 1 adhesively attached to its external bottom wall. The flow damping gauze 1 may cover the vent hole 321 and may be for adjusting the air flow within the accommodating space 32.

Above the bass sound unit 100 may overlay a first dust cover 10. The sound from the bass sound unit 100 may be channeled through a first sound hole 11 of the first dust cover 10, while the sound from the treble sound unit 2 may be channeled through a second sound hole 12 of another dust cover. In short, the bass sound unit 100 and the treble sound unit 2 may not share the same dust cover.

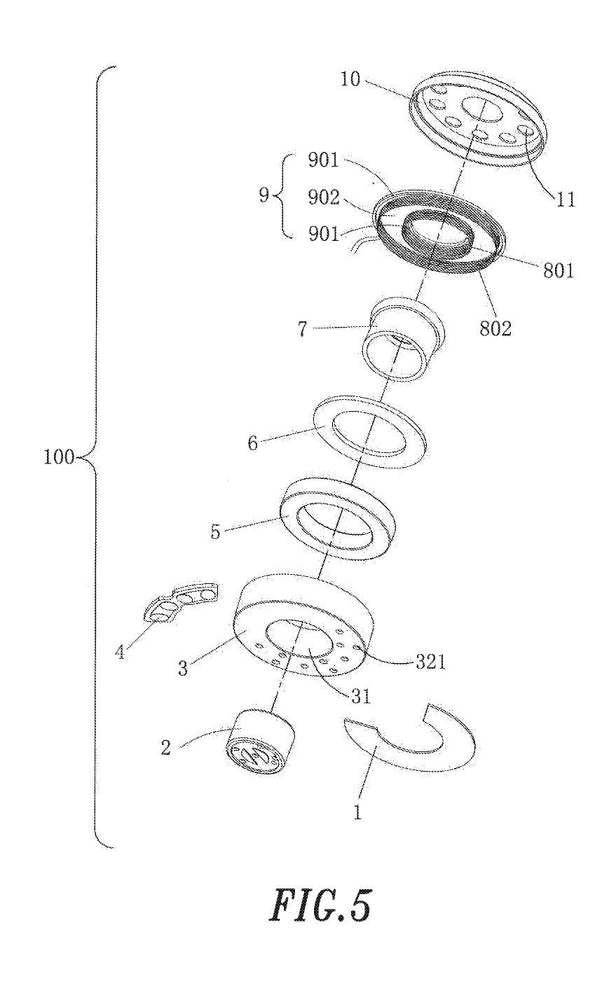

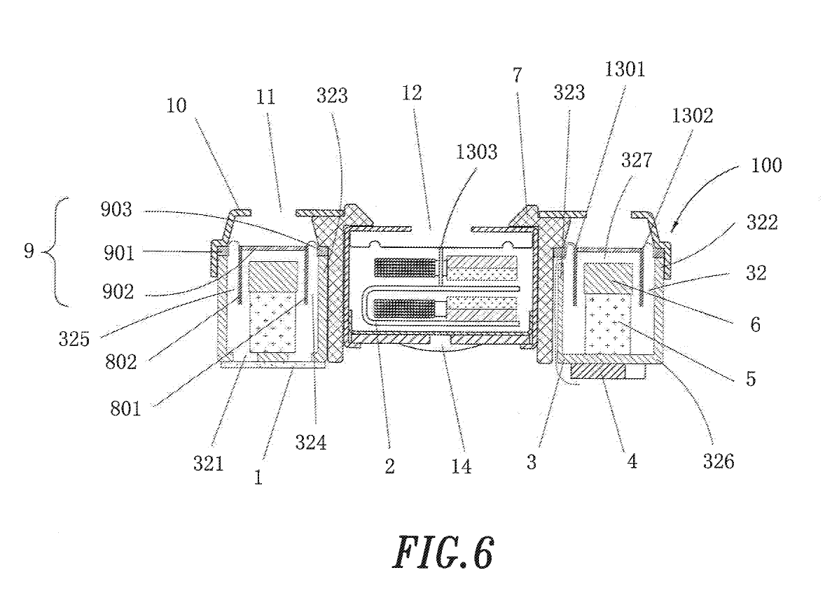

Please refer to FIGS. 5-6 illustrating another embodiment according to the present disclosure. Difference between the embodiment shown in both FIGS. 5 and 6 and the embodiment in FIGS. 1-4 includes a magnetic resistant ring 7 may lie at the position where the bass sound unit 100 and the treble sound unit 2 are adjoined. The magnetic resistant ring 7 may be implemented in terms of a column structure and may be penetrated by the treble sound unit 2 while the magnetic-conductive base 3 of the bass sound unit 100 may surround the magnetic resistant ring 7. Consequently, the magnetic resistant ring 7 may isolate the magnetic fields of the treble sound unit 2 from the magnetic fields of the bass sound unit 100.

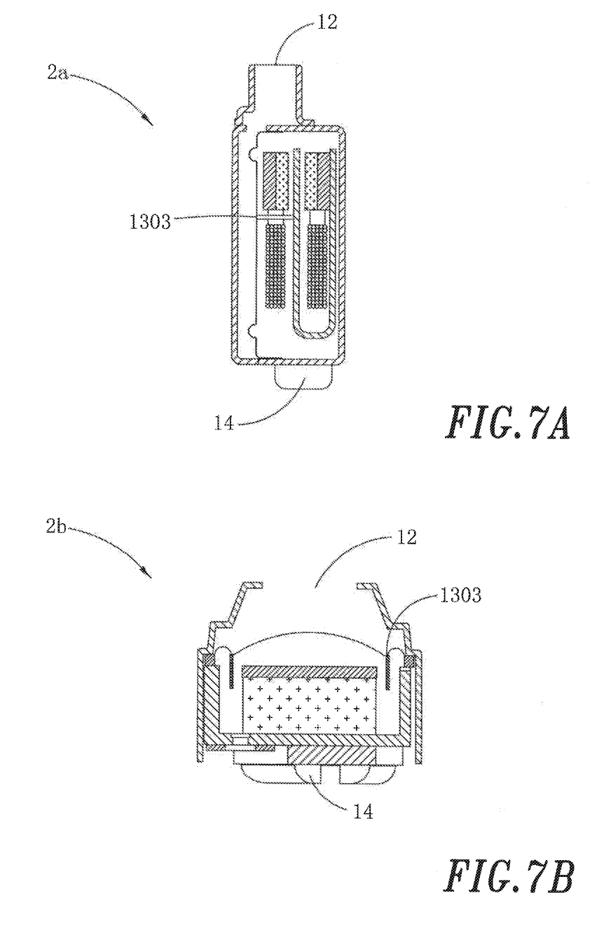

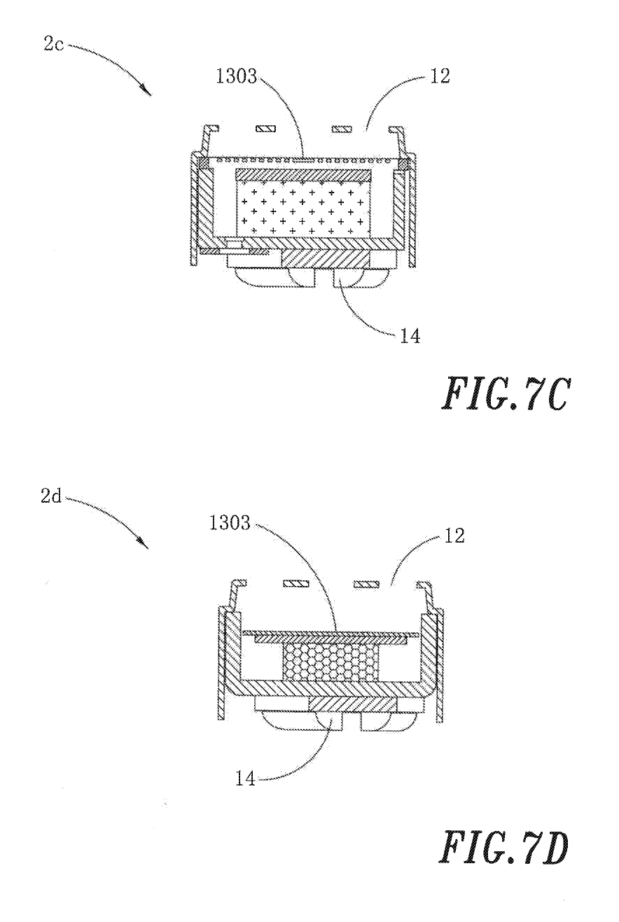

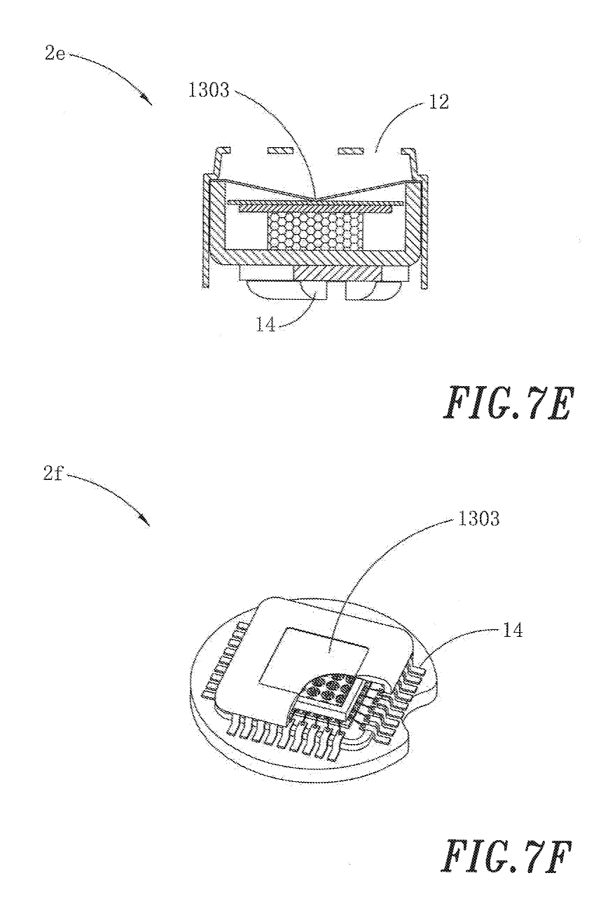

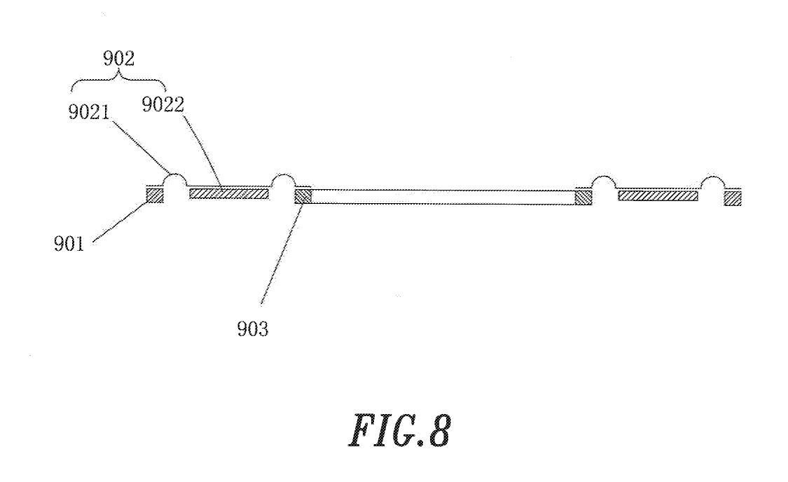

As shown in FIG. 7A to FIG. 7F, the treble sound unit 2 may be a rectangular electromagnetic moving iron sound unit 2a (FIG. 7A), a moving-coil sound unit 2b (FIG. 7B), a ribbon-type sound unit 2c (FIG. 7C), piezo-ceramic sound piece components 2d (FIG. 7D), a piezo-ceramic sound piece adjoining another vibrating vocal tone diaphragm 2e (FIG. 7E), or a semiconductor chip sound unit 2f (FIG. 7F). All of the foregoing embodiments may be used to replace the moving iron treble sound unit 2. All of the embodiments (2a-20 in FIGS. 7A-7F may include the wiring board 14 for the treble sound unit and the vibration audio source point 1303. The semiconductor chip sound unit 2f may not be equipped with the sound hole. On the other hand, the treble sound hole 12 may be present in other embodiments 2a-2f.

The embodiments in FIGS. 1-8 may be applicable in a variety of different audio speakers or earphones. The earphones, for instance, may include in-ear headphones, ear canal headphones, back neck earphones, and headphones.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

1. A multi-vocal coil coaxial audio speaker comprising:
a treble sound unit with a vibration audio source point and a wiring board; and
a bass sound unit in form of a dual magnetic gap mechanism, the bass sound unit having a vibrating vocal tone diaphragm with multiple vocal coils with a first vibration audio source point and a second vibration audio source point, and a wiring board;
wherein the bass sound unit and the treble sound unit are coaxially disposed and the treble sound unit is adapted to be surrounded by the bass sound unit;
wherein the vibration audio source point of the treble sound unit horizontally aligns with the first vibration audio source point and the second vibration audio source point of the bass sound unit.

2. The audio speaker according to claim 1, wherein the treble sound unit is an electromagnetic moving iron sound unit, a circular electromagnetic sound unit, a rectangular electromagnetic sound unit, a moving-coil sound unit, piezo-ceramic sound piece components, a piezo-ceramic sound piece adjoining another vibrating vocal tone diaphragm or a semiconductor chip sound unit.

3. The audio speaker according to claim 1, further comprising a magnetic resistant ring disposed at the position where the co-axially disposed bass sound unit and treble sound unit adjoin, for separating a magnetic field of the bass sound unit and a magnetic field of the treble sound unit.

4. The audio speaker according to claim 3, wherein the magnetic resistant ring is a column structure allowing for the treble sound unit to punch through and position therein with a magnetic-conductive base of the bass sound unit surrounding the magnetic resistant ring.

5. The speaker according to claim 1, wherein the bass sound unit further comprises:
a ring-shaped magnetic-conductive base, the ring-shaped magnetic conductive base defining a hollow positioning space at its center within which the treble sound unit is positioned, a main body of the ring-shaped magnetic-conductive base having a ring-shaped accommodating space having a top opening, and the main body of the ring-shaped magnetic-conductive base forming an inner wall and an outer wall of the top opening;
a ring-shaped magnet disposed at the center of the accommodating space, and a first magnetic gap and a second magnetic gap formed between the ring-shaped magnet and the inner wall and the outer wall, respectively;
a magnetic-conductive ring stationed on a top surface of the ring-shaped magnet;
the vibrating vocal tone diaphragm having a ring-shaped diaphragm membrane stationed on ends of the inner wall and the outer wall of the main body of the ring-shaped magnetic-conductive base, a first vocal coil disposed in the proximity of an inner ring edge of the diaphragm membrane, a second vocal coil disposed in the proximity of an outer ring edge of the diaphragm membrane, the first vibration audio source point formed at the position where the first vocal coil adjoins the diaphragm membrane, the second vibration audio source point formed at the position where the second vocal coil adjoins the diaphragm membrane, and the first vocal coil extending into the first magnetic gap, the second vocal coil extending into the second magnetic gap, and the ring-shaped magnet positioned between the first magnetic gap and the second magnetic gap; and
the wiring board disposed on an external bottom surface of the ring-shaped magnetic-conductive base providing connection wires for positioning the first vocal coil and the second vocal coil.

6. The audio speaker according to claim 5, wherein the vibrating vocal tone diaphragm further comprises an external pressurized frame positioned at the outer ring edge of the ring-shaped diaphragm membrane and an inner pressurized frame positioned at the inner ring edge of the ring-shaped diaphragm membrane, the inner pressurized frame connects to the end of the inner wall of the ring-shaped magnetic-conductive base, and the outer pressurized frame connects to the end of the outer wall and encloses the top opening of the ring-shaped magnetic-conductive base.

7. The audio speaker according to claim 5, wherein a vent hole is disposed on the external bottom surface of the ring-shaped magnetic-conductive base allowing for an air associated with the vibration of the vibrating vocal tone diaphragm to be channeled out of the ring-shaped accommodating space.

8. The audio speaker according to claim 7, further comprising a flow damping gauze adhesively attached on the external bottom surface of the ring-shaped magnetic-conductive base for adjusting an air flow within the accommodating space

9. The audio speaker according to claim 5, wherein the ring-shaped diaphragm membrane is in form of composite diaphragm material composed of an upper layer composite thin-film membrane and a lower layer composite thin-film membrane.

10. The audio speaker according to claim 5, further comprising a first dust cover disposed over the bass sound unit and a second dust cover disposed over the treble sound unit, with the first dust cover having a first sound hole allowing for the sound from the bass sound unit to be transmitted out of the first dust cover, and the second dust cover having a second sound hole allowing for the sound from the treble sound unit to be transmitted out of the second dust cover.
